(19) United States
(12) Patent Application Publication
(10) Pub. No.: US 2026/0227184 A1
(43) Pub. Date: Aug. 6, 2026

(54) REFRACTORY MONITORING SYSTEM FOR HIGH-VOLTAGE AND HIGH-TEMPERATURE ENVIRONMENT APPLICATIONS

(71) Applicant: PANERATECH, INC., Chantilly, VA (US)

(72) Inventors: Yakup BAYRAM, Chantilly, VA (US); Alexander RUEGE, Chantilly, VA (US); John DONAHOO, Chantilly, VA (US)

(21) Appl. No.: 19/150,611

(22) PCT Filed: Jan. 24, 2023
(86) PCT No.: PCT/US2023/061160

§ 371 Date: Jul. 24, 2025

(51) Int. Cl. G01B 15/02; G01S 7/02; H01Q 13/02

(52) U.S. Cl. CPC G01B 15/02; G01S 7/023; G01S 7/027; H01Q 13/02

(57) ABSTRACT

Disclosed is a system for monitoring the status of a material exposed to a high-voltage and high-temperature environment, such as the refractory material in an electric furnace. The system is operative to collect data from a sensor disposed in the proximity of such material, while incorporating protective elements for operating at a 2000° F. temperature and a 3.0 KV voltage to reduce the overall downtime during the inspection and prevent potential personnel injuries as well as furnace and equipment damage. Additionally, the system comprises a processor and data processing software to account for harsh environment effects while determining certain flaws, including the deformation of, and presence of gaps within, the refractory material. This allows determining the thickness of the refractory material, timely warning about the risks of furnace operation, achieving higher operational safety, and more accurately estimating both the remaining operational life and the maintenance plan of the furnace.

### FIELD OF THE INVENTION

The present invention relates to systems for evaluating the status of a material. More particularly, the present invention relates to systems for monitoring the status of a material forming part of a vessel used in manufacturing, while exposed to a high-voltage and high-temperature environment.

### BACKGROUND OF THE INVENTION

A variety of manufacturers, including those in the glass, plastic, and metallurgical industries, use vessels such as furnaces and ladles, to melt, treat, refine, and transport the raw material used for processing. Some of these vessels may reach a length equivalent to the height of a 20-story building and are key assets for manufacturers in terms of costs and operational functionality. In order to minimize the internal heat loss at high operating temperatures, which may be in excess of 2000° F., these furnaces and ladles are constructed using refractory material, having very high melting temperatures and good insulation properties, to create a refractory melting chamber. However, the innermost refractory walls of a manufacturing vessel will degrade during operation. The effects of this degradation include refractory erosion, refractory corrosion, stress cracks, and refractory material diffusion into the molten material.

On the other hand, as the refractory material degrades over time, the molten material may accumulate on the degraded surface of or penetrate into the refractory material, accelerating the degradation process and creating a higher risk for molten material leakage through the refractory wall with potentially devastating consequences. In addition, due to the extreme operating conditions, stress cracks can grow over time and create gaps within the refractory material, which may lead to bending or deformation of the internal wall or to a partial collapse of the vessel's refractory material. As a result, the measured thickness of the refractory material may depend on the measurement technique used and be uncertain, which would mislead manufacturers regarding the actual thickness of the refractory material. Accordingly, manufacturers may face an increased risk of experiencing either an unexpected leakage of molten material through the vessel wall or an increased uncertainty to conservatively shut down the vessel for re-build or repair to reduce the likelihood of any potential leakage, based on the manufacturer's experience of the expected lifetime of the vessel.

In manufacturing vessels, the surface condition of internal and external walls, slag buildup, refractory material thickness and homogeneity, rate of erosion of the refractory material, and level and rate of penetration of molten material into the refractory material are some of the important aspects that may require monitoring and evaluation. The importance of these aspects relies on their role to provide useful information to estimate the thickness of such material and the remaining operational life of the vessel. Several evaluation systems and methods have been disclosed within various industries for measuring the thickness of a material, using one or a combination of more than one of a variety of devices or techniques, including ultrasound units, thermal imaging cameras, radars, infrared detectors, stereovision cameras, LIDAR, and laser scanners, to ultimately indicate whether the condition of the manufacturing vessel is suitable for operation.

Particularly, manufacturing vessels need to be maintained for removal of residues and inspection of the refractory material in a regular basis, and sometimes repaired as often as on a weekly basis, during their lifetime. Therefore, it is not unusual for a metallurgical vessel to be shut down for maintenance multiple times a year. Further, each shut down can last up to several days, translating into a negative impact on the operational life and productivity of the vessel. Accordingly, in a manufacturing vessel, minimizing both the cooling down time to perform inspections and the heat up time to reach operational temperatures directly translates into higher productivity of the vessel. As a result, the ability to perform inspections at temperatures as high as possible may be crucial to reduce the overall down time of the vessel.

Specifically, electric glass furnace operation typically involves the use of high-voltage electrodes immersed in the glass either as electric boosting, providing 5% to 20 % of the total energy input, or all-electric melting. The immersed electrodes are connected to a power supply and transformer, to pass an electric current through the glass. In all-electric furnaces, the melting energy comes from the electrodes, with a gas burner being used for the initial start-up, or as an emergency heat source. These furnaces mainly operate with the raw material distributed evenly over the melting surface of the glass, forming an insulating batch blanket. However, as melting and refining take place, the high temperatures inside the furnace increase the electrical conductivity of both the molten material and the refractory material disposed between the exterior of the furnace and the molten material. Accordingly, since the high-voltage electrodes are immersed in the molten material and the refractory material is in physical contact with the molten material, the outermost surface of the refractory material of the furnace may reach a high-voltage level of up to 3.0 KV.

Importantly, when inspecting the refractory material of an electric furnace with a sensor, there might be the need for the sensor and/or an accessory of the sensor to get very close to or into physical contact with the outermost surface of the refractory material of the furnace. This may translate into an injury to the inspector due to an electrical shock or damage to the sensor system or the furnace, unless precautionary measures are taken, which may include reducing the voltage applied to the furnace electrodes. However, this will translate into cooling down the electric furnace resulting in an increased down time and reduced productivity.

As a result, measurement and processing techniques and systems, along with computational software and other hardware, are required to be integrated with high-temperature and high-voltage sensors to effectively address these issues. In other words, a system can be used to monitor the status and determine the thickness of and how the refractory material of the vessel is deteriorating to improve the operational safety of the manufacturing process, while collecting the data using sensors operating at temperatures of up to 2000° F. and electrically isolated from voltages of up to 3.0 KV, such that there is no risk if personnel or the sensors come into physical contact with refractory material exposed to this high-voltage level.

Specifically, the determination of the thickness of refractory material in a manufacturing vessel has been addressed in the prior art, as described in U.S. Pat. No. 6,198,293 to Woskov et al. and U.S. Pat. No. 9,255,794 to Walton et al. However, these efforts are based on the use of microwave signals that penetrate the material of interest, such as a furnace wall, to measure its thickness and have faced certain challenges and limitations. In particular, attempts made to determine furnace wall thickness on hot furnaces have been generally unsuccessful because of the large signal losses involved in evaluating the innermost surface of refractory materials, especially at relatively high-frequency bands. Likewise, at relatively low frequency bands signals still experience losses and are limited in terms of the bandwidth and resolution required by existing systems. These losses are proportional to the degree of electrical conductivity of the refractory material, which increases with temperature.

Additional attempts have been made to assess the status and thickness of a refractory lining using laser scanning, which uses signals that do not penetrate the material under test, as described in U.S. Pat. No. 10,859,316 to Richter et al. However, this approach is constrained to collecting multiple laser scans of the interior of the vessel prior and after each heat of the vessel, while the vessel is empty (not processing molten material) and when the interior of the vessel is cool (not at operating temperatures), to determine an exposure impact of the heat on the refractory lining by comparing the collected pre-heat structural condition data with the collected post-heat structural condition data. Another limitation faced by this attempt is that the predictability of the refractory material condition is ineffective since determination of the exposure impact is based only on comparing laser scans prior and after each heat without considering all the heats in which the refractory material under evaluation has been involved. In addition, the use of laser scanning becomes ineffective when inspecting the outermost surface of the refractory material.

Further attempts have been made to evaluate the status of a material, using electromagnetic wave sensors, by reducing the losses and level of spurious signals involved in evaluating refractory materials, as described in U.S. Pat. No. 10,151,709 to Bayram et al., U.S. Pat. No. 9,880,110 to Ruege et al., and U.S. Pat. No. 10,054,367 to Bayram et al. However, these systems are primarily aimed to mitigate the effects caused by the multiple reflections of the electromagnetic waves used, as an attempt to reduce the clutter associated with a received signal. A further attempt to integrate electromagnetic wave sensors embedded in the refractory material of a metallurgical vessel has been addressed in the prior art, as described in International PCT App. No. PCT/US2021/025706 by Bayram and International PCT App. No. PCT/US2021/063960 by Bayram. However, these approaches are limited to metallurgical vessels wherein the refractory material is not exposed to high-voltage levels. All these attempts have focused on standalone systems used primarily for non-electric furnaces, wherein the refractory material of the furnace is not exposed to high-voltage levels and there is no risk of an electric shock to personnel or equipment. As a result, these efforts become ineffective in the case of an electric furnace.

In general, the flow of molten material, such as molten glass or molten steel, at high temperatures erodes and degrades the innermost surface of the refractory material and creates a high risk for molten material leakage through the refractory wall or a severe damage to the outermost shell of the vessel. Furthermore, a leak of molten material may cause significant damage to the equipment around the vessel and, most importantly, put at risk the health and life of workers. For these reasons, in most cases vessel relining is conducted at a substantially earlier time than needed. This leads to significant costs for manufacturers in terms of their initial investment and the reduced production capacity over the operational life of the vessel.

Thus, it is critical for manufacturing vessel operators to efficiently plan maintenance and monitor refractory material degradation of the vessel walls to extend the operational life of the vessel and plan required outages of the vessel when it is necessary. The lifetime and operational capability of a ladle or furnace is linked to the degradation and thickness of the refractory material over time, which might be affected by a number of factors, including the operational age, the average temperature of operation, the heating and cooling temperature rates, the range of temperatures of operation, the number of cycles of operation, the type and quality of the refractory material, the slag buildup on the innermost refractory walls as well as the load and type of the molten material and additives in contact with the refractory lining. Each of these factors is subject to uncertainties that make it difficult to create accurate estimates of the expected lifetime of a furnace and when to perform the corresponding maintenance tasks.

Accordingly, determining the thickness of refractory material in manufacturing vessels is crucial in industries where asset uptime is critical and asset downtime must be maintained to a minimum, while operating safely. Accurately determining the refractory material thickness will enable manufacturers to minimize repairs and keep the asset uptime. Therefore, there is a need, which is fulfilled by the present invention, to accurately determine the thickness of the refractory material in an electrical furnace, using a sensor while the furnace is operating at high temperatures and high-voltage levels. In addition, the present invention may allow to assess the potential presence of gaps within the refractory material and the level of bending and deformation of such material, which will affect the determination of the refractory material thickness. As a result, vessel operators will have ample time to properly plan for maintenance and more safely operate the vessel, since as the refractory material gets thinner, the likelihood of a leakage of molten material gets higher.

Currently, there is no well-established system that can deterministically estimate the condition of the refractory material in an electrical furnace, while the data is collected next to such material, and the vessel is maintained operating at high temperatures and exposed to high voltages. The lack of such system impairs the ability to operate the furnace with a higher safety confidence and to more accurately estimate both the remaining operational life and the maintenance plan. In addition, for safety considerations, the use of existing system would require to at least shut down the furnace for inspection. Thus, there remains an opportunity for a system, based on the integration of a sensor system, capable of withstanding high temperature and high voltages, with computational software and additional hardware, to accurately monitor and determine the operational condition of the refractory material of electric furnaces.

### SUMMARY OF THE INVENTION

A system for monitoring the status of a material exposed to a high-voltage and high-temperature environment, such as the refractory material in an electric furnace is disclosed herein. One or more aspects of exemplary embodiments provide advantages while avoiding disadvantages of the prior art. The system is operative to collect data from a sensor disposed in the proximity of such material, while incorporating protective elements for operating it at a 2000° F. temperature and a 3.0 KV voltage to reduce the overall downtime during the inspection and prevent potential personnel injuries as well as furnace and equipment damage. Additionally, the system comprises a processor and data processing software to account for harsh environment effects while determining certain flaws, including the deformation of, and presence of gaps within, the refractory material. This allows determining the thickness of the refractory material, timely warning about the risks of furnace operation, achieving higher operational safety, and more accurately estimating both the remaining operational life and the maintenance plan of the furnace.

The system for monitoring the status of a refractory material forming part of a manufacturing vessel, such as an electric furnace, comprises two primary subsystems. First, a sensor subsystem to collect data for characterizing the internal condition of the material under evaluation and to collect reference positioning data of the furnace, while operating in a high-temperature and high-voltage environment. Second, a data processing subsystem to process the data collected using a computational algorithm for determining the thickness of the refractory lining and certain flaws, such as the presence of gaps within the refractory material. These flaws can be determined by processing the data collected by the sensor subsystem and/or collecting additional data to correlate the processed data with a condition or level of degradation of this material.

In particular, the sensor subsystem comprises a transceiver (transmitter and receiver) of radiofrequency signals and a sensor head comprising at least one antenna to transmit and receive signals through the refractory material of the electric furnace. The transceiver collects data from the received signals, related to the presence of discontinuities, which may represent a flaw, associated with the refractory material, including those within and those corresponding to the innermost and outermost surfaces of the refractory material, as applicable. Additionally, the sensor may collect reference positioning data corresponding to the outermost surface of the refractory material under evaluation. The sensor head is able to collect all the data in a high-temperature and high-voltage environment. Accordingly, the system further comprises at least one element for protecting the sensor and attached sensor accessories, including cables, connectors, adapters, extension arms, and the like, to operate in such environment. A plurality of elements can be used for protection, including specific temperature-and high-voltage-resistant materials, such as glass cloth tape, electrical insulation/fire-proof sleeves and jackets, ceramic-based sensors and sensor covers, certain types of sensor radomes, and the like.

The data processing subsystem comprises a main computer-based processor further comprising a data storage device and an executable computer code or computational algorithm, configured to process the data collected by the sensor subsystem, other historical data, operational and process parameters, and the user's input. Then, by processing and correlating the reference positioning data associated to the innermost and outermost surfaces of the refractory material, the system can determine the spacing between these surfaces to ultimately determine the thickness of the refractory material of the furnace at that specific location. Likewise, by determining the positioning of a discontinuity within the refractory material relative to the positioning of either the innermost or outermost surfaces of the refractory material, the system can estimate the location of such discontinuity within the refractory material.

Moreover, time domain-based and/or frequency domain-based signal processing techniques or a combination of both may be used to determine and visualize the status of the evaluated area of interest. Thus, the data processing subsystem can generate a variety of outcomes as a result of evaluating a manufacturing vessel. These outcomes may include a determination or estimation of the remaining thickness, the surface profile, or the rate of degradation over time of the refractory material of the vessel as well as the potential presence of a gap within the refractory material. Accordingly, these outcomes can be used to early warn a user about the future operation of the vessel or the remaining operational life of the vessel.

During data collection, the sensor head is preferably disposed in proximity to, but not necessarily in physical contact with, the refractory material of the manufacturing vessel. More preferably, a portable system comprising different attachment mechanisms might be used with the sensor head to physically position the sensor proximate to one or more locations of the outermost surface of the refractory material. Alternatively, one or more sensors may be used to collect information prior, during, or after operation of the vessel and may be disposed not in physical contact with, embedded in the refractory material of, or in physical contact with the vessel, according to the type of sensor used. In this alternative arrangement, one or more sensors may transmit the data collected to allow a continuous monitoring over time of the material under evaluation.

By integrating at least one sensor subsystem with customized computer processing tools and a computer-based processor, the system is able to determine the remaining thickness of the refractory material of a vessel, while collecting data in a high-temperature and high-voltage environment. This translates into more effective and accurate scheduling to better manage the costly processes of metallurgical vessel repairs, decommissioning, or replacement along with a significant reduction of the level of risk of an operational break or leakage of molten material or severe damage to the vessel. Thus, the system allows a more effective operational assessment of manufacturing vessels, which may result in a reduction of operational uncertainty and safer operations along with a potential extent of the operational life and an improved maintenance scheduling of such costly assets.

### BRIEF DESCRIPTION OF THE DRAWINGS

The numerous advantages of the present invention may be better understood by those skilled in the art by reference to the accompanying drawings in which:

FIG. 1 shows a schematic side view of a first exemplary embodiment of a system and a set up for collecting data in a high-temperature and high-voltage environment for monitoring a status of a refractory material in an electric furnace.

FIG. 2 shows a schematic side view of a second exemplary embodiment of a system and a set up for collecting data in a high-temperature and high-voltage environment for monitoring a status of a refractory material in an electric furnace.

FIG. 3 shows a schematic side view of a sensor subsystem for collecting data in a high-temperature and high-voltage environment for monitoring a status of a refractory material in an electric furnace.

### DETAILED DESCRIPTION OF THE INVENTION

The following description is of particular embodiments of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other systems for carrying out the same purposes of the present invention. Those skilled in the art should also realize that such equivalent assemblies do not depart from the spirit and scope of the invention in its broadest form.

The system for monitoring the status of a refractory material used as a wall of a manufacturing vessel, such as an electric furnace, comprises a sensor subsystem and a data processing subsystem. The sensor subsystem comprises at least one element for protecting the sensor and attached sensor accessories, including cables, connectors, adapters, extension arms, and the like, to operate in such environment. Further, the sensor subsystem characterizes the presence of discontinuities within the refractory material under evaluation and collects reference positioning data points of the electric furnace. The data processing subsystem uses a computational algorithm for determining the thickness of the refractory material. However, the data processing subsystem may also determine or estimate the surface profile and the rate of degradation over time of the refractory material of the vessel as well as the potential presence of a gap within the refractory material.

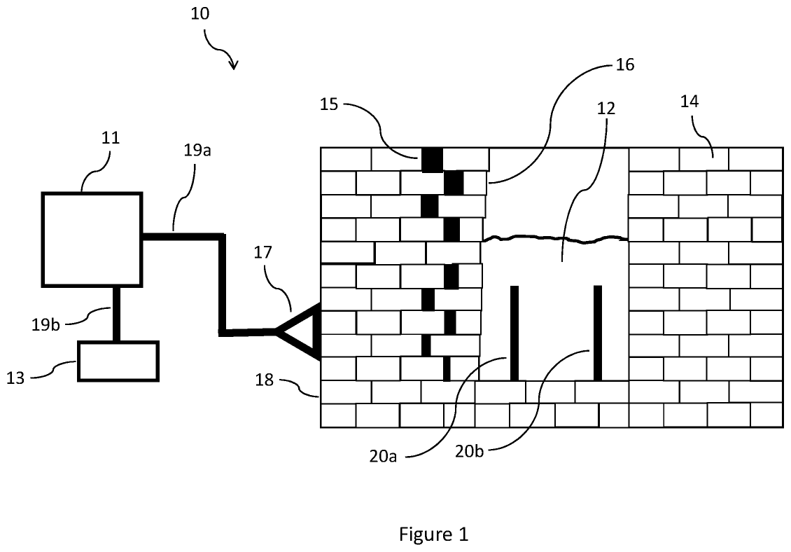

In accordance with certain aspects of an embodiment of the invention, FIG. 1 shows a schematic side view of a first exemplary embodiment of a monitoring system 10 and a set up for collecting data in a high-temperature and high-voltage environment for monitoring a status of a refractory material 14 forming part of an electric furnace, in accordance with a first exemplary embodiment. Refractory material 14 is disposed in one or more layers at least partly surrounding a molten material 12, such as glass, contained within the electric furnace. Typically, the various layers of refractory material 14 are formed using bricks disposed side-by-side from bottom to top of the electric furnace. Accordingly, refractory material 14 forms one or more walls surrounding molten material 12. Thus, refractory material 14 has an innermost surface 16 and an outermost surface 18 opposite innermost surface 16. Innermost surface 16 of refractory material 14 is contiguous to (i.e., in contact with) molten material 12.

In this particular embodiment, system 10 comprises a sensor, such as an antenna 17, disposed in the vicinity of outermost surface 18 of refractory material 14 under evaluation. Preferably, antenna 17 is contiguous to outermost surface 18 of refractory material 14. More preferably, antenna 17 is positioned such that a transmit signal from antenna 17 propagates through refractory material 14 to reach at least part of innermost surface 16 that is closer to antenna 17. System 10 further comprises a transceiver 11 capable of transmitting and receiving radiofrequency signals, and a set of cables 19a to couple transceiver 11 to antenna 17 as well-known to those skilled in the art. System 10 further comprises a computer-based processor 13 with a data storage device, and a set of cables 19b to couple transceiver 11 to computer-based processor 13 as well-known to those skilled in the art. It is understood that at least part of computer-based processor 13 and the data storage device can be integrated with transceiver 11. Moreover, at least partly, transceiver 11 may be integrated with antenna 17. It is noted that components of transceiver 11 and computer-based processor 13 have not been shown as these components are not critical to the explanation of this embodiment.

During monitoring of a status of refractory material 14, the radiofrequency signals transmitted by transceiver 11 through antenna 17 are partly reflected from innermost surface 16 that is closer to antenna 17. This reflection is due to the media discontinuity faced by the propagating radiofrequency signals at the interface between refractory material 14 and molten material 12. Likewise, the radiofrequency signals transmitted by transceiver 11 through antenna 17 may also be partly reflected from a media discontinuity at the interface between antenna 17 and outermost surface 18 of refractory material 14 or any other media discontinuity within refractory material 14. Typically, any media discontinuity within refractory material 14 may be indicative of the presence of a flaw or an extraneous material, such as molten material, within refractory material 14. Preferably, antenna 17 is positioned such that a transmit signal from antenna 17 impinges substantially perpendicular to outermost surface 18 of refractory material 14.

The radiofrequency signals reflected from innermost surface 16 that are received by antenna 17 are then sent to transceiver 11 for further treatment, storing, and processing. Transceiver 11 measures the amplitude and phase of the received signals over one or more frequency bands in the 0.5 GHz to 70 GHz range. Moreover, upon the processing of these signals using one or more signal processing methods in frequency and/or time domain, as well-known by those skilled in the art, system 10 is capable of determining a corresponding thickness of refractory material 14, the presence of certain flaws, including deformation, gaps, and penetration of molten material 12 within refractory material 14 over a region under evaluation. In addition, system 10 may also determine or estimate the surface profile and the rate of degradation over time of refractory material 14.

In particular, the presence of a gap 15 within refractory material 14 can be characterized by determining the location and dimensions of gap 15. Specifically, by timing the reflected signals received by antenna 17, corresponding to the discontinuity between an edge of gap 15 and refractory material 14, the location of gap 15 may be determined. In addition, by timing the difference between the reflected signals received by antenna 17, corresponding to the discontinuity between the edge of gap 15 closer to innermost surface 16 of refractory material 14 and the corresponding edge of gap 15 closer to outermost surface 18, the dimensions of gap 15 may be determined. Moreover, by timing the reflected signals received by antenna 17, corresponding to the discontinuity at innermost surface 16 of refractory material 14, over a certain region of innermost surface 16, a profile of innermost surface 16 over that region may be generated to determine the level of bending of innermost surface 16.

Optionally, the entire monitoring system 10 may be packaged into a single portable unit in which an operator triggers the transmission of radiofrequency signals, over a frequency band, by activating a switch. More specifically, the entire monitoring system 10 may be enclosed in a single handheld unit. The unit may evaluate the status of refractory material 14 at a single point and record the information in a built-in memory. Alternatively, part of the transceiver may be integrated with antenna 17 into a single assembly to transmit the radiofrequency signals and to only measure, record, and store the amplitude and phase of the reflected signals received by antenna 17. Then the stored data may be transferred to computer-based processor 13 using a portable memory drive or by means of a flexible cable for evaluating the status, or ultimately determining the thickness, of the subject material under evaluation. Alternatively, the data may be transferred wirelessly in real time or at a convenient opportunity.

Furthermore, the handheld unit may include data processing components and a display to show the thickness of the furnace wall and/or the distance from either innermost or outermost surfaces of refractory material 14 to a discontinuity embedded in the material under evaluation. The portable unit may be designed to scan by hand an area of the furnace wall while taking measurements at multiple locations. Moreover, system 10 may be periodically used for one or more evaluations of said material under evaluation or may be installed permanently and fixed onto outermost surface 18 of refractory material 14 under evaluation to continuously monitor the status of the material under evaluation. Alternatively, a region of the outermost surface 18 of refractory material 14 may be scanned by moving antenna 17, during operation, over and while maintaining physical contact with outermost surface 18 of the material under evaluation.

During operation of the electric furnace, at least two high-voltage electrodes 20a, 20b are immersed in molten material 12. More specifically, electrodes 20a, 20b have a high-voltage difference between them to produce a high electric current to pass through, generate heat, and melt the raw material. However, as melting takes place, the high temperatures inside the furnace increase the electrical conductivity of both molten material 12 and refractory material 14. As a result, molten material 12 and refractory material 14, including outermost surface 18, may reach a high-voltage level of up to 3.0 KV. In addition, during evaluation of refractory material 14, using system 10, antenna 17 might be either in physical contact or within a few millimeters from outermost surface 18 of refractory material 14 or other supporting structures, such as steel bars or steel gratings, that might be in physical contact with refractory material 14. As a result, these supporting structures might reach the same high-voltage level as refractory material 14. Therefore antenna 17, might be exposed to such high voltage. Likewise, any system components, including set of cables 19a, other components of system 10, and an operator of system 10 might also be exposed to a high voltage.

Accordingly, a mechanical attachment, such as a pole, using a quick-connect system to easily attach to antenna 17 may be used to prioritize usability of monitoring system 10, to increase the accessibility of antenna 17, to extend the locations of refractory material 14 that may be reachable by antenna 17, and very importantly, to reduce the risk of exposure of equipment and personnel to the high-voltage level that may reach outermost surface 18 of refractory material 14. The mechanical attachment should be capable to withstand the temperatures of outermost surface 18 and voltages of up to 3.0 KV and to carry along set of cables 19 a. In particular, the mechanical attachment might be constructed of a material comprising fiberglass or ceramic. Alternatively, the mechanical attachment might be protected by one or more layers of protective material, such as clothing tape.

Preferably, the mechanical attachment is extendable and flexible, such as a gooseneck type for accessing tight spots, and provides certain self-alignment with a wall of refractory material 14. More preferably, the mechanical attachment is also rugged, light weight, and collapsible to fit into a carry-on sized case. Those skilled in the art will realize that other types of mechanical attachments may be used to enhance the access of antenna 17 to areas of refractory material 14 that may be difficult to access. These mechanical attachments may include telescopic poles, foldable elements, angled-section arms, and retractable parts.

In an alternative configuration, and still with reference to FIG. 1, antenna 17 and/or at least part of set of cables 19a may be fixed in a permanent manner to refractory material 14 under evaluation of the electric furnace. Those skilled in the art will realize that antenna 17 and or at least part of set of cables 19a may be mechanically attached to refractory material 14 using a bonding means capable of withstanding the high temperatures typically existing on outermost surface 18 of refractory material 14. Likewise, a mechanical structure (not shown) may be used to attach antenna 17 and or at least part of set of cables 19a to refractory material 14, as well-known in the art.

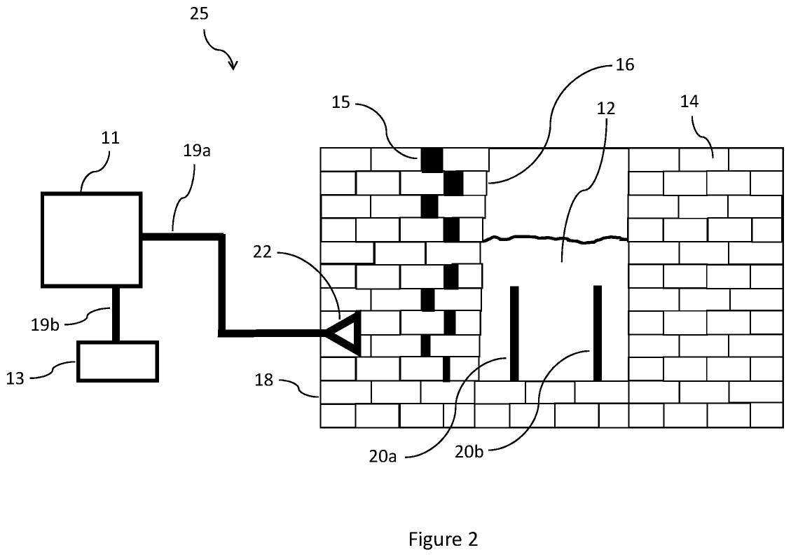

Alternatively, FIG. 2 shows a schematic side view of a system 25 and a set up for collecting data in a high-temperature and high-voltage environment for monitoring a status of a refractory material 14 forming part of an electric furnace, in accordance with a second exemplary embodiment. Refractory material 14 is disposed in one or more layers at least partly surrounding a molten material 12, such as glass. Typically, the various layers of refractory material 14 are formed using bricks disposed side-by-side from bottom to top of the electric furnace. Accordingly, refractory material 14 forms one or more walls surrounding molten material 12. As a result, at least part of an innermost surface 16 of refractory material 14 is in physical contact with molten material 12.

In this particular embodiment, system 25 comprises one antenna 22, embedded within refractory material 14. Preferably, antenna 22 is embedded in one of the layers of refractory material 14. More preferably, antenna 22 is positioned such that a transmit signal from antenna 22 propagates through refractory material 14 to reach at least part of innermost surface 16 that is closer to antenna 22. System 25 further comprises a transceiver 11 capable of transmitting and receiving radiofrequency signals and a set of cables 19a to couple transceiver 11 to antenna 22. System 25 further comprises a data storage device, a computer-based processor 13, and a set of cables 19b to couple transceiver 11 to computer-based processor 13. It is understood that either or both of the data storage device and computer-based processor 13 can be integrated with transceiver 11. Moreover, at least partly, transceiver 11 may be integrated with antenna 22. It is noted that components of transceiver 11, storage device, and computer-based processor 13 have not been shown as these components are not critical to the explanation of this embodiment.

During monitoring of a status of refractory material 14, the radiofrequency signals transmitted by transceiver 11 through antenna 22 are partly reflected from innermost surface 16 that is closer to antenna 22. This reflection is due to the media discontinuity faced by the propagating radiofrequency signals at the interface between refractory material 14 and molten material 12. Likewise, the radiofrequency signals transmitted by transceiver 11 through antenna 22 may also be partly reflected from a media discontinuity at the interface between antenna 22 and refractory material 14 or any other media discontinuity within the region between antenna 22 and innermost surface 16 of refractory material 14. Typically, any media discontinuity within refractory material 14 may be indicative of the presence of a flaw or an extraneous material, such as molten material, within refractory material 14. Preferably, antenna 22 is positioned such that a transmit signal from antenna 22 impinges substantially perpendicular to innermost surface 16 of refractory material 14.

The radiofrequency signals reflected from innermost surface 16 that are received by antenna 22 are then sent to transceiver 11 for further treatment, storing, and processing. Transceiver 11 measures the amplitude and phase of the received signals over one or more frequency bands in the 0.25 GHz to 70 GHz range. Moreover, upon the processing of these signals using one or more signal processing methods in frequency and/or time domain, as well-known by those skilled in the art, system 25 is capable of determining a corresponding thickness of refractory material 14, the presence of certain flaws, including deformation, gaps, and penetration of molten material 12 within refractory material 14 over a region under evaluation. In addition, system 25 may also determine or estimate the surface profile and the rate of degradation over time of refractory material 14.

In particular, the presence of a gap 15 within refractory material 14 can be characterized by determining the location and dimensions of gap 15. Specifically, by timing the reflected signals received by antenna 22, corresponding to the discontinuity between an edge of gap 15 and refractory material 14, the location of gap 15 may be determined. In addition, by timing the difference between the reflected signals received by antenna 22, corresponding to the discontinuity between the edge of gap 15 closer to innermost surface 16 of refractory material 14 and the corresponding edge of gap 15 closer to outermost surface 18, the dimensions of gap 15 may be determined. Moreover, by timing the reflected signals received by antenna 22, corresponding to the discontinuity at innermost surface 16 of refractory material 14, over a certain region of innermost surface 16, a profile of innermost surface 16 over that region may be generated to determine the level of bending of innermost surface 16.

Preferably, more than one antenna 22 is installed within refractory material 14. This allows to monitor the status of refractory material 14 continuously over a larger region of the furnace walls. Optionally, antenna 22 might be embedded in refractory material 14 using one or more casted refractory bricks, such that antenna 22 fits into refractory material 14 without having gaps between antenna 22 and refractory material 14. However, this is only possible to implement during the initial construction or during major repairs of the furnace.

During operation of the electric furnace, at least two high-voltage electrodes 20a, 20b are immersed in molten material 12. More specifically, electrodes 20a, 20b have a high-voltage difference between them to produce a high electric current to pass through, generate heat, and melt the raw material. However, as melting takes place, the high temperatures inside the furnace increase the electrical conductivity of both molten material 12 and refractory material 14. As a result, molten material 12 and refractory material 14, including outermost surface 18, may reach a high-voltage level of up to 3.0 KV. In addition, during evaluation of refractory material 14, using system 25, antenna 22 is embedded, and as such in physical contact with outermost surface 18 of refractory material 14. Therefore, antenna 22 is exposed to such high voltage. Likewise, any system components, including set of cables 19a, other components of system 25, and an operator of system 25 may also be exposed to a high voltage.

In reference to FIGS. 1 and 2, each antenna 17 and 22 is designed to tolerate the required temperature range of outermost surface 18. In a preferred configuration, the material that is used to form antenna 17, 22 is selected to withstand such high temperatures (the area of antenna 17, 22 exposed to the highest temperature being the area placed contiguous to the furnace outermost surface 18). Likewise, antenna 17, 22 is made of a material capable of withstanding voltages of up to 1.5 KV. Alternatively, antenna 17, 22 comprises at least one protective element to withstand such voltage levels.

Preferably antenna 17, 22 comprises a pyramidal horn antenna having a rectangular cross-section, further comprising a first flared plate having a planar section and two flared sections along opposite side edges of such planar section of the first flared plate, and a second flared plate positioned opposite the first flared plate, wherein such second flared plate comprises a planar section and two flared sections along opposite side edges of such planar section of such second flared plate. As an example, a pyramidal horn antenna configured to have a maximum rectangular cross-section of 3.5 inches by 2.8 inches and a minimum rectangular cross-section of 1.9 inches by 1.5 inches with a depth of 2.8 inches might operate in the 0.25 GHz to 10 GHz frequency band. Typically, a standard horn antenna will have a thickness-to-length ratio of the flared plates in the order of less than 5%. However, in a preferred configuration, the thickness-to-length ratio of first and second flared plates is in the range of 15% to 85%.

More preferably, each of antennas 17 and 22 further comprises a dielectric material disposed in at least a portion of a volumetric region, between the first flared plate and the second flared plate, which extends beyond the two flared sections along the opposite side edges of the first flared plate and the second flared plate. Most preferably, the dielectric material has a dielectric permittivity that matches the dielectric permittivity of refractory material 14 to smooth out the media discontinuity between such dielectric material and refractory material 14. Alternatively, the refractory material itself is used as the dielectric material.

Those skilled in the art will realize that different types of antennas other than a horn antenna and/or having or not smooth rolled edges may be used in systems 10 and 25. More specifically, horn antennas having four flared plates; non-pyramidal horn antennas, such as conical or the like; or horn antennas with non-rectangular cross-section, such as elliptical, may be used. Likewise, those of ordinary skill in the art will realize that systems 10 and 25 may further comprise various arrangements of radiofrequency components, such as filters, impedance matching networks, amplifiers, non-coherent detectors and other test instrumentation used in different ways to implement the measurement of transmitted and reflected radiofrequency signals and perform the functions of transceiver 11 and the computer-based processor 13 as are known in the prior art. Furthermore, those skilled in the art will realize that sets of cables 19a and 19b can be replaced with a wireless system to couple antenna 22 to transceiver 11 and computer processor 13 to transceiver 11, respectively.

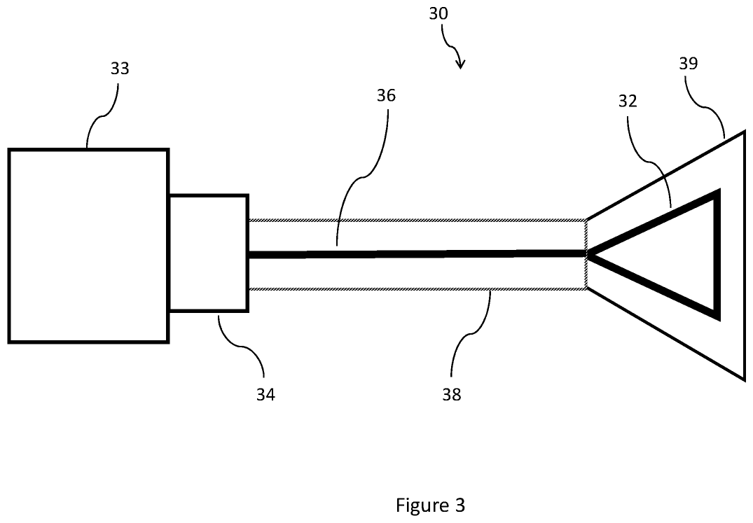

FIG. 3 shows a schematic side view of a sensor subsystem 30 for collecting data in a high-temperature and high-voltage environment for monitoring a status of a refractory material in an electric furnace. Specifically, sensor subsystem 30 comprises one antenna 32 to be ultimately coupled to a transceiver 33 of radiofrequency signals via a set of cables 36. In this particular configuration, sensor subsystem 30 further comprises a first protective element 39, a second protective element 38, and a third protective element 34.

First protective element 39 is configured to protect antenna 32 against a high voltage and high temperatures that may result from approaching or physically contacting antenna 32 to a high-voltage and high-temperature source, such as the outermost surface of the refractory material in an electric furnace (not shown) while in operation. More specifically, first protective element 39 performs as both an electrical and a thermal isolator to prevent voltages of up to 3.0 KV and temperatures of up 2000° F. from affecting the performance of or damaging antenna 32 or other components of sensor subsystem 30. First protective element 39 comprises one or more of glass cloth tape, ceramic-based covers, radomes, and the like. Preferably, first protective element 39 comprises a glass cloth tape made of fiberglass to provide an effective layer of both electrical and thermal insulation between antenna 32 and the surrounding environment, including refractory material 14 and other supporting structures, such as steel bars or steel gratings, that might be in physical contact with antenna 32 during evaluation of refractory material 14.

Those skilled in the art would realize that more than one layer of first protective element 39 may be used to provide additional protection to antenna 32. More preferably, first protective element 39 comprises a ceramic-based cover. Most preferably, first protective element 39 comprises a ceramic-based sensor. In particular, the application of first protective element in more than one layer provides additional protection since several layers provide an increased thickness of first protective element, which increases the thickness, and as a result, the effective dielectric strength of the first protective element, as well-known in the prior art.

Likewise, second protective element 38 is configured to protect set of cables 36 against both high voltage and high temperatures that may result from approaching or physically contacting antenna 32 to a high-voltage and high-temperature source, such as the outermost surface of the refractory material in an electric furnace (not shown) while in operation. More specifically, second protective element 38 performs as both an electrical and a thermal isolator to prevent voltages of up to 3.0 KV and temperatures of up 2000° F. from affecting the performance of or damaging set of cables 36 or other components of sensor subsystem 30. Second protective element 38 comprises one or more of electrical insulating tube sleeving, glass cloth tape, and the like. Preferably, second protective element 38 comprises an electrical insulating tube sleeving made of coated fiberglass to provide an effective layer of both electrical and thermal insulation between set of cables 36 and the surrounding environment.

Moreover, third protective element 34 is configured to protect transceiver 33 against a high voltage that may result from approaching or physically contacting antenna 32 to a high-voltage source, such as the outermost surface of the refractory material or other supporting structures in an electric furnace (not shown) while in operation. More specifically, third protective element 34 performs as an electrical isolator or blocker to prevent high voltages and voltage peaks from reaching transceiver 33 through set of cables 36. In addition, this type of third protective element 34 typically also protects transceiver 33 against electromagnetic interference caused by return currents created by the voltage difference that might exists between transceiver 33 and the outermost surface of the refractory material under evaluation.

Those skilled in the art would realize that at least part of transceiver 33 might be located next to or integrated with antenna 32. In such case, set of cables 36 may comprise communication and power cables to electrically connect transceiver 33 to a computer-based processor (not shown). As a result, third protective element 34 might be configured to isolate transceiver 33 from set of cables 36 and prevent high-voltage levels from passing onto set of cables 36, as well-known in the prior art. Likewise, those skilled in the art would realize that one or more of third protective element 34 might be configured to be connected in series to provide an additional level of protection.

Moreover, with regard to the dielectric material forming part of antenna 17 or first protective element 39, such as ceramic-based materials, typically these ceramic-type materials withstand temperatures much higher than the maximum expected temperature of outermost surface 18 of refractory material 14. Preferably, the selection of such materials will allow disposing antenna 17 against a surface having a temperature as high as 2000° F. for at least a few seconds, which is sufficient to take the necessary data for operation of systems 10 and 25.

The various embodiments have been described herein in an illustrative manner, and it is to be understood that the terminology used is intended to be in the nature of words of description rather than of limitation. Any embodiment herein disclosed may include one or more aspects of the other embodiments. The exemplary embodiments were described to explain some of the principles of the present invention so that others skilled in the art may practice the invention.

The present system for monitoring the status of a refractory material forming part of an electric furnace to determine the thickness of the refractory material in a high-temperature and high-voltage environment and for providing information to estimate the remaining operational life and to improve the maintenance plan of the vessel has been disclosed herein in an illustrative manner. It is to be understood that the terminology which has been used is intended to be in a descriptive rather than in a limiting nature. Those skilled in the art will recognize that many modifications and variations of the invention are possible in light of the above teachings. The present invention may be practiced otherwise than as specifically described within the scope of the appended claims and their legal equivalents.

We claim:

1. A system for monitoring a status of a refractory material forming part of an electric furnace, wherein an innermost surface of said refractory material of said electric furnace is exposed to a molten material different from said refractory material, said system comprising:
a sensor subsystem comprising at least one antenna and a transceiver of radiofrequency signals for collecting a set of data associated with said status of said refractory material; and
a data processing subsystem comprising a computer-based processor, wherein said computer-based processor comprises a data storage device and an executable computer code configured to process said set of data;
wherein said sensor subsystem further comprises a first set of cables to couple said transceiver of radiofrequency signals to said at least one antenna, and at least one first electrical protective element to insulate said at least one antenna from voltages of up to 3.0 KV, wherein said at least one first electrical protective element further provides thermal insulation to said at least one antenna from temperatures of up to 2000°F, and wherein said data processing subsystem further determines a thickness of at least a region of said refractory material based on said set of data.

2. The system of claim 1, wherein said thickness of said refractory material is determined based on a correlation of said set of data with an element selected from a group of a prior status of said refractory material and information provided by a user.

3. The system of claim 1, wherein said first electrical protective element comprises one or more elements selected from a group of a glass cloth tape, a ceramic-based cover, a ceramic-based sensor, and a radome.

4. The system of claim 1, wherein said sensor subsystem further comprises at least one second electrical protective element to insulate said set of cables from voltages of up to 3.0 KV and wherein said at least one second electrical protective element further provides thermal insulation to said set of cables from temperatures of up to 2000°F.

5. The system of claim 4, wherein said second electrical protective element comprises one or more elements selected from a group of a glass cloth tape and an electrical insulating tube sleeving.

6. The system of claim 1, wherein said sensor subsystem further comprises at least one third electrical protective element to insulate said transceiver of radiofrequency signals from voltages of up to 3.0 KV and to protect said transceiver against electromagnetic interference.

7. The system of claim 6, wherein said third electrical protective element comprises at least one electrical isolator.

8. The system of claim 1, wherein said sensor subsystem further comprises at least one third electrical protective element to insulate said transceiver of radiofrequency signals from a second set of cables to protect said second set of cables against voltages of up to 3.0 KV.

9. The system of claim 1, wherein said at least one antenna is installed in at least part of said electric furnace for continuous monitoring over time of said status of said refractory material.

10. The system of claim 1, wherein said at least one antenna is at least partly embedded in said refractory material.

11. The system of claim 10, wherein said at least one antenna is at least partly embedded in at least one casted portion of said refractory material.

12. The system of claim 1, wherein said sensor subsystem is portable.

13. The system of claim 1, further comprising a mechanical attachment having a first end coupled to said at least one antenna and a second end coupled to at least one element of said sensor subsystem, wherein said mechanical attachment enables an extension of a distance between said at least one antenna and said at least one element of said sensor subsystem.

14. The system of claim 13, wherein said first end of said mechanical attachment comprises a quick-connect system to enable said at least one antenna to easily couple to said first end of said mechanical attachment.

15. The system of claim 13, wherein said mechanical attachment comprises at least one element selected from a group of a gooseneck unit, a collapsible part, a flexible piece, a telescopic pole, a foldable component, an angled-section arm, and a building block to enable said at least one antenna to reach out to an area of said refractory material having difficult access.

16. The system of claim 13, wherein said mechanical attachment comprises an electrical protective element.

17. The system of claim 13, wherein at least part of said mechanical attachment comprises an element selected from a group of a fiberglass-based material and a ceramic-based material.

18. The system of claim 1, wherein said at least one antenna has an end, which conforms to a surface of said refractory material.

19. The system of claim 1, wherein said at least one antenna comprises a pyramidal horn antenna having a rectangular cross-section and comprising a first flared plate having a planar section and two flared sections along opposite side edges of said planar section of said first flared plate, and a second flared plate positioned opposite said first flared plate, said second flared plate comprising a planar section and two flared sections along opposite side edges of said planar section of said second flared plate.

20. The system of claim 19, wherein a thickness-to-length ratio of said at least one of said first flared plate and said second flared plate is within the range of 15% to 85%.

21. The system of claim 19, wherein at least a portion of a volumetric region between said first flared plate and said second flared plate comprises a dielectric material, which extends beyond said two flared sections along said opposite side edges of said planar section of at least one of said first flared plate and said second flared plate.

22. The system of claim 1, wherein said sensor subsystem collects data associated with a reference positioning of said innermost surface of said refractory material and a reference positioning associated with an outermost surface of said refractory material of said electric furnace.

23. The system of claim 1, wherein said data processing subsystem is further configured to estimate a presence and dimensions of one or more gaps within, a bending of, and a wearing of said innermost surface of said refractory material of said electric furnace, based on historical, statistical, and trending data, corresponding to at least one of a previous evaluation of said refractory material, a user's input information, an operational parameter, and a process parameter.

24. The system of claim 1, wherein said data processing subsystem is further configured to perform an action selected from a group of estimating a remaining operational life of said electric furnace and enhancing a maintenance plan of said electric furnace.
